(19) United States
(12) Patent Application Publication
(10) Pub. No.: US 2021/0107266 A1
(43) Pub. Date: Apr. 15, 2021

(54) ANTIBACTERIAL PLASTIC SURFACE MATERIAL

(71) Applicant: NAN YA PLASTICS CORPORATION, TAIPEI (TW)

(72) Inventors: TE-CHAO LIAO, TAIPEI (TW); CHING-YAO YUAN, TAIPEI (TW); Chih-Feng Wang, TAIPEI (TW)

(21) Appl. No.: 17/008,929

(22) Filed: Sep. 1, 2020

(30) Foreign Application Priority Data
Oct. 15, 2019 (TW) 108137120

(51) Int. Cl. B32B 27/32; B32B 27/08; B32B 27/40; B32B 27/30; B32B 7/12

(52) U.S. Cl. CPC B32B 27/322; B32B 27/08; B32B 2307/7145; B32B 27/308; B32B 7/12; B32B 27/40

(57) ABSTRACT

An antibacterial plastic surface material is provided. The antibacterial plastic surface material includes a polyolefin substrate and an antifouling and antibacterial layer. A material of the polyolefin substrate includes 30 wt % to 60 wt % of linear polyethylene and 40 wt % to 70 wt % of propylene homopolymer. The antifouling and antibacterial layer is formed on the polyolefin substrate. The material of the antifouling and antibacterial layer includes at least 70 wt % of a fluorine-containing polymer.

### CROSS-REFERENCE TO RELATED PATENT APPLICATION

This application claims the benefit of priority to Taiwan Patent Application No. 108137120, filed on Oct. 15, 2019. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a plastic surface material, and more particularly to an antifouling and antibacterial surface material.

### BACKGROUND OF THE DISCLOSURE

Conventional antifouling and antibacterial surface material includes a polyvinylchloride (PVC) film as a main body and a mesh fabric disposed on the PVC film After the mesh fabric is printed by ink, an antifouling and antibacterial coating is formed onto the mesh fabric; thereby, the conventional antifouling and antibacterial surface material is manufactured.

PVC has advantages of good processibility, low cost and good flame retardant performance, and is therefore widely used. During a process for manufacturing PVC products, an addition of a plasticizer can increase the softness of the PVC products. Therefore, the PVC products with different softness and hardness can be manufactured by adjusting an amount of the plasticizer that is used according to different requirements. Accordingly, using PVC as a material of products has advantages of a low technical threshold for production and a low material cost.

Whereas, PVC has a poor thermal stability so that hydrogen chloride gas, chlorine gas, and other toxic gases are easy to release at a temperature higher than 148° C. Further, when PVC is incompletely burned, dioxin or other pollutes will be generated. Gases generated or cracked from PVC at high temperature will pollute the environment and damage human bodies. Accordingly, heavy metal, such as lead, cadmium, or zinc, is usually added into the PVC so as to enhance the thermal stability of the PVC.

However, after being used for a long time, plasticizers and stabilizers contained in PVC may be released from PVC film due to changes of temperature and humidity in environment. The released plasticizers and stabilizers not only damage the environment and human bodies but also form stains, mold, or peel off from the plastic surface material. Therefore, due to the limitation of PVC, conventional antifouling and antibacterial surface material poses some potential risks to the environment and safety. In addition, the release of plasticizers may shorten the lifetime of the antifouling and antibacterial surface material.

### SUMMARY OF THE DISCLOSURE

In response to the above-referenced technical inadequacies, the present disclosure provides an antibacterial plastic surface material.

In one aspect, the present disclosure provides an antibacterial plastic surface material. The antibacterial plastic surface material includes a polyolefin substrate and an antifouling and antibacterial layer formed on the polyolefin substrate. A material of the polyolefin substrate includes 30 wt % to 60 wt % of linear polyethylene and 40 wt % to 70 wt % of propylene homopolymer. A material of the antifouling and antibacterial layer includes at least 70 wt % of a fluorine-containing polymer.

In certain embodiments, the present disclosure provides an antibacterial plastic surface material. The fluorine-containing polymer is at least one selected from the group consisting of: polyvinylidene difluoride, polytetrafluoroethylene, and polyvinylfluoride.

In certain embodiments, the present disclosure provides an antibacterial plastic surface material. The antifouling and antibacterial layer includes at least one auxiliary layer and at least one fluorine-containing polymer layer, and the polyolefin substrate connects with the auxiliary layer or the fluorine-containing polymer layer; wherein the fluorine-containing polymer layer includes the fluorine-containing polymer, and a content of the fluorine-containing polymer based on a total weight of the antibacterial plastic surface material ranges from 70 wt % to 90 wt %.

In certain embodiments, the present disclosure provides an antibacterial plastic surface material. A material of the at least one auxiliary layer is polymethylmethacrylate, polyurethane resin, or a combination thereof.

In certain embodiments, the present disclosure provides an antibacterial plastic surface material. The antifouling and antibacterial layer is a laminated structure, and the at least one auxiliary layer and the at least one fluorine-containing layer are staggeringly disposed on the polyolefin substrate.

In certain embodiments, the present disclosure provides an antibacterial plastic surface material. The polyolefin substrate connects with the at least one auxiliary layer, and an adhesive is formed between the polyolefin substrate and the at least one auxiliary layer.

In certain embodiments, the present disclosure provides an antibacterial plastic surface material. A thickness of the antifouling and antibacterial layer is 10 μm to 50 μm.

In certain embodiments, the present disclosure provides an antibacterial plastic surface material. The antibacterial plastic surface material further includes a patterned self-adhesive layer discretely formed on a surface of the polyolefin substrate opposite to the antifouling and antibacterial layer.

In certain embodiments, the present disclosure provides an antibacterial plastic surface material. The patterned self-adhesive layer includes a plurality of adhesive units arranged regularly and a plurality of exhaust channels, and every two of the adhesive units are separated by the exhaust channel.

In certain embodiments, the present disclosure provides an antibacterial plastic surface material. The antifouling and antibacterial layer is formed on the polyolefin substrate by laminating.

Therefore, by virtue of “a polyolefin substrate 10 whose material includes 30 wt % to 60 wt % of linear polyethylene and 40 wt % to 70 wt % of propylene homopolymer” and “a material of the antifouling and antibacterial layer 20 includes at least 70 wt % of a fluorine-containing polymer”, the antibacterial plastic surface material possess the antifouling and antibacterial properties.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a side view of an antifouling and antibacterial surface material according to a first embodiment of the present disclosure.

FIG. 2 is a side view of the antifouling and antibacterial surface material according to a second embodiment of the present disclosure.

FIG. 3 is a side view of the antifouling and antibacterial surface material according to a third embodiment of the present disclosure.

FIG. 4 is a perspective view of the antifouling and antibacterial surface material according to a fourth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

In order to overcome the deficiency existing in the conventional antibacterial plastic surface material, an antibacterial plastic surface material having antifouling and antibacterial effects is provided by the present disclosure. The conventional PVC film is replaced by a polyolefin substrate so that the problems of poor thermal stability of PVC film and the release of plasticizers from PVC film can be overcome. The antibacterial plastic surface material includes an antifouling and antibacterial layer formed from a fluorine-containing solution to achieve the antifouling and antibacterial effects. The antibacterial plastic surface material can be applied in wall covering, handle, or other objects often be touched in children's hospitals or obstetrics and gynecology hospitals. Accordingly, hygiene of hospitals can be maintained easily so that children can be distant from a wall full of bacterial. Moreover, for the moisture-proof and anti-mold effects, the antibacterial plastic surface material also can be used as a decorative material of advanced home appliances, such as refrigerator.

### First Embodiment

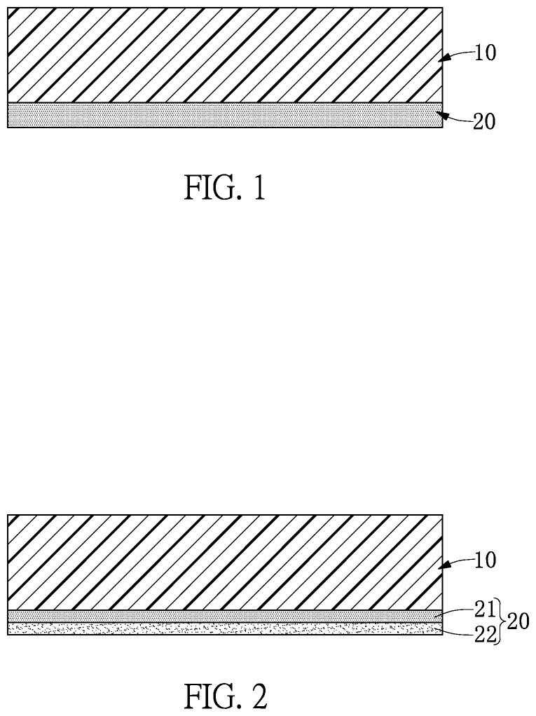

Referring to FIG. 1, an antibacterial plastic surface material of the present disclosure includes a polyolefin substrate 10 and an antifouling and antibacterial layer 20 formed on the polyolefin substrate 10. For example, the antibacterial plastic surface material can be used as a wall covering of plastic products, a surface material, or a decorative material, but the present disclosure is not limited thereto.

The polyolefin substrate 10 has advantages of strong physical properties and good weather resistance. Therefore, the polyolefin substrate 10 can be used as a main body of the antibacterial plastic surface material and can support the antifouling and antibacterial layer 20. The antifouling and antibacterial layer 20 is formed on the polyolefin substrate 10 and has antifouling and antibacterial effects. In other words, the antifouling and antibacterial layer 20 can prevent dust particles or grease from attaching onto the antibacterial plastic surface material and avoid bacteria multiplying. Therefore, when the antifouling and antibacterial layer 20 disposed onto the polyolefin substrate 10 as a continuous film, the antifouling and antibacterial layer 20 can protect the polyolefin substrate 10. The continuous film means that a surface of the polyolefin substrate 10 is totally covered by the antifouling and antibacterial layer 20 so that the polyolefin substrate 10 will not be exposed to outside.

In the present embodiment, a main material of the polyolefin substrate 10 includes polyethylene and polypropylene. Generally, a texture of polyethylene is relatively soft and a texture of polypropylene is relatively tough. Therefore, a hardness of the polyolefin substrate 10 can be controlled by adjusting a content ratio of polyethylene and polypropylene. That is, the antibacterial plastic surface material can have an appropriate hardness by adjusting the content ratio of polyethylene and polypropylene so as to enhance convenience of use and flexibility of the antibacterial plastic surface material. For example, the appropriate hardness of the antibacterial plastic surface material helps users to laminate the antibacterial plastic surface material onto an object. Accordingly, the hardness of the polyolefin substrate 10 can be adjusted without using plasticizers so that the problems derived from plasticizers in the conventional technology can be solved.

In the present embodiment, a material of the polyolefin substrate 10 includes 30 wt % to 60 wt % of polyethylene and 40 wt % to 70 wt % of polypropylene. In a preferable embodiment, the material of the polyolefin substrate 10 includes 30 wt % to 50 wt % of polyethylene and 50 wt % to 70 wt % of polypropylene so that the polyolefin substrate 10 can have an appropriate hardness that meets requirements.

In the material of the polyolefin substrate 10, polyethylene can be ethylene homopolymer, ethylene copolymer, or a mixture thereof. Ethylene homopolymer is polymerized from only ethylene as monomers. A polydispersity of ethylene homopolymer ranges from 1.5 to 3.5. The polydispersity means a ratio of weight-average molecular weight over number average molecular weight which is abbreviated as Mw/Mn. Ethylene copolymer is polymerized from ethylene and other monomers. A polydispersity of ethylene copolymer is over 3.5. For example, ethylene copolymer can be polymerized from ethylene and α-olefin. In the present embodiment, a carbon number of α-olefin ranges from 3 to 12; preferably, the carbon number of α-olefin ranges from 4 to 8. Specifically, α-olefin can be propylene, 1-butylene, 1-hexene, 4-methyl-1-pentylene, or 1-octylene. For example, ethylene copolymer can be polymerized from ethylene and an unsaturated ester. In the present embodiment, the unsaturated ester can be but not limited to vinyl acetate, acrylate, or methacrylate. In addition, polyethylene can be classified into high density polyethylene (HDPE), low density polyethylene (LDPE), linear low density polyethylene (LLDPE), or metallocene polyethylene (mPE), but is not limited thereto. In a preferable embodiment, polyethylene is linear polyethylene.

In the material of the polyolefin substrate 10, polypropylene can be propylene homopolymer (PP-H), propylene block copolymer (PP-B), or polypropylene random copolymer (PP-R). In a preferable embodiment, polypropylene is propylene homopolymer.

In the present embodiment, the material of the polyolefin substrate 10 includes linear polyethylene and propylene homopolymer so that the polyolefin substrate 10 has good processibility and thermal stability.

Besides the foresaid polyethylene and polypropylene, the material of the polyolefin substrate 10 further includes nanoscale titanium dioxide (such as titanium dioxide whose average diameter ranges from 1 nm to 100 nm), a crosslinker, and an antistatic agent.

The addition of nanoscale titanium dioxide promotes appropriate crosslinking between polyethylene and polypropylene, so that the weather resistance and the physical properties of the polyolefin substrate 10 are enhanced.

The crosslinker can be, but not limited to: succinic acid peroxide (110° C.), benzoyl peroxide (110° C.), tert-butyl 2-ethylhexanoate (113° C.), p-chlorobenzoyl peroxide (115° C.), tert-butyl peroxyisobutyrate (115° C.), tert-butyl peroxyisopropyl carbonate (135° C.), tert-butyl dodecaneperoxoate (140° C.), 2,5-dimethyl-2,5-bis(benzyloxyperoxy)hexane (140° C.), tert-butyl peroxyacetate (140° C.), di-tert-butyl peroxyphthalate ester (140° C.), tert-butyl peroxymaleate (140° C.), cyclohexanone peroxide (145° C.), tert-butyl peroxybenzoate (145° C.), dicumyl oxide (150° C.), 2,5-dimethyl-2,5-bis(tert-butyl peroxide)hexane (155° C.), tert-butyl cumyl peroxide (155° C.), tert-butyl hydrogen peroxide (158° C.), di-tert-butyl peroxide (160° C.), 2,5-dimethyl-2,5-di(tert-butylperoxy)hexyne (170° C.) or α,α′-bis-tert-butylperoxy-1,4-diisopropylbenzene (160° C.). Temperatures (° C.) between the brackets represent decomposition temperatures of the crosslinkers. Among the crosslinker, 2,5-dimethyl-2,5-di(tert-butylperoxy)hexyne and α,α′-bis-tert-butylperoxy-1,4-diisopropylbenzene have high decomposition temperatures; hence, physical properties and appearance of whom is easy to be controlled. Therefore, the crosslinker may not crosslink during a mixing step and may not inhibit the subsequent processing steps.

In addition, after adding the antistatic agent, a polyolefin mixture can form a conductive surface to avoid accumulation generating static sparks. Specifically, the antistatic agent can be ethoxyglycerol fatty acid esters, phosphate esters, fatty amine derivatives, alcohol derivatives, and combinations thereof. Specifically, the antistatic agent can be alkyl phosphate or polyethylene glycol stearate.

In the present embodiment, the polyolefin substrate 10 is manufactured by steps below. Polyethylene, polypropylene, nanoscale titanium dioxide, the crosslinker, and the antistatic agent are added in a mixer to form a polyolefin mixture. Subsequently, the polyolefin mixture is fed into a diaphragm molding machine and is held at a temperature of 150° C. to 220° C. After being fully crosslinked and gelatinized, the polyolefin mixture is calendered at a temperature of 170° C. to 200° C. After cooling, the polyolefin substrate 10 of the present disclosure is obtained.

The antifouling and antibacterial layer 20 is formed on the polyolefin substrate 10. Specifically, the antifouling and antibacterial layer 20 is disposed on the polyolefin substrate 10 via an adhesive. In other embodiment, the antifouling and antibacterial layer 20 can be directly disposed on the polyolefin substrate 10 without the adhesive. Whether the adhesive is disposed or not depends upon the material of the antifouling and antibacterial layer 20 and the method for manufacturing the antifouling and antibacterial layer 20. The present disclosure is not limited thereto.

Based on the total weight of the antifouling and antibacterial layer 20, a material of the antifouling and antibacterial layer 20 includes at least 70 wt % of a fluorine-containing polymer. An appropriate amount of the fluorine-containing polymer can enhance the antifouling property, the antibacterial property, and weather resistance of the antibacterial plastic surface material. The fluorine-containing polymer is at least one selected from the group consisting of polyvinylidene fluoride (PVDF), polytetrafluoroethylene (PTFE), and polyvinyl fluoride (PVF). Preferably, the fluorine-containing polymer is PVDF, PVF, or a combination thereof. In a preferable embodiment, the material of the antifouling and antibacterial layer 20 further includes a silver-containing compound to reinforce the antibacterial property of the antifouling and antibacterial layer 20.

In the present embodiment, a thickness of the antifouling and antibacterial layer 20 ranges from 10 μm to 50 μm. In practical operation, the thinner the antifouling and antibacterial layer 20 is, the lower the material cost is. In a preferable embodiment, the thickness of the antifouling and antibacterial layer 20 ranges from 10 μm to 20 μm.

In the present embodiment, the antifouling and antibacterial layer 20 is manufactured by steps as follows. A fluorine-containing solution is prepared. The fluorine-containing solution is coated onto a release film by a slot die coater. Subsequently, the release film with the fluorine-containing solution is dried at a temperature of 180° C. to 220° C. (preferably 200° C.). After the fluorine-containing solution is dried, a fluorine-containing polymer film is formed on the release film Lastly, the fluorine-containing polymer film is peeled from the release film and wound, and then a fluorine-containing polymer film roll is obtained. The fluorine-containing polymer film can be directly disposed onto the polyolefin substrate 10 without any adhesive and then the antifouling and antibacterial layer 20 is formed. A material of the release film is polyethylene terephthalate (PET). However, the present disclosure is not limited thereto.

Specifically, the fluorine-containing solution includes 70 wt % to 100 wt % of the fluorine-containing polymer, 0 wt % to 30 wt % of an auxiliary polymer, 0 wt % to 1 wt % of a fluorine-containing leveling agent or a fluorine-free leveling agent, 0 wt % to 1 wt % of an ionic dispersant or a non-ionic dispersant, and a solvent. In other words, in the fluorine-containing solution, at least 70 wt % of the fluorine-containing polymer is an essential component, while the auxiliary polymer, the fluorine-containing leveling agent or the fluorine-free leveling agent, the ionic dispersant or the non-ionic dispersant, and solvent are optional components.

Specifically, the solvent can be dimethylformamide (DMF), dimethyl carbonate (DMC), and dimethylacetamide (DMAC), but is not limited thereto. The auxiliary polymer can be polymethyl methacrylate (PMMA), polyurethane (PU), or a combination thereof. However, the present disclosure is not limited thereto.

It should be noted that when the fluorine-containing solution is absent from the auxiliary polymer, the antifouling and antibacterial layer 20 containing high concentration of fluorine is formed, which has good antifouling property and antibacterial property. When the fluorine-containing solution includes the fluorine-containing polymer and the auxiliary polymer, a composite film containing the fluorine-containing polymer and the auxiliary polymer can be obtained, such as PVDF/PMMA composite film Although the concentration of fluorine of the antifouling and antibacterial layer 20 is decreased, the material cost for manufacturing the antifouling and antibacterial layer 20 is also reduced. Accordingly, in practice, the amount of the fluorine-containing polymer can be adjusted according to specific antifouling and antibacterial standards required by products.

Moreover, the antifouling and antibacterial layer 20 further includes an ultraviolet light absorber, a flame retardant, and an antibacterial agent so as to optimize other properties of the antibacterial plastic surface material, but is not limited thereto. The ultraviolet light absorber can be one or more of hydroxyphenyl benzotriazole ultraviolet absorber and hydroxybenzophenone ultraviolet absorber. The flame retardant can be a phosphorus flame retardant or a nitrogen flame retardant. The phosphorus flame retardant can be a phosphate ester flame retardant, an ammonia phosphate flame retardant, or an aromatic phosphoric acid compound. In other embodiments, the flame retardant also can be metal hydroxide, magnesium hydroxide, aluminum hydroxide, or zinc borate.

### Second Embodiment

In the present disclosure, the antifouling and antibacterial layer 20 can not only be a single layer but also be a laminated structure. Referring to FIG. 2, the antifouling and antibacterial layer 20 of the second embodiment is a laminated structure. The antifouling and antibacterial layer 20 includes an auxiliary layer 21 and a fluorine-containing polymer layer 22. The auxiliary layer 21 connects with the polyolefin substrate 10, and an adhesive can be disposed between the auxiliary layer 21 and the polyolefin substrate 10. In other embodiments, the fluorine-containing polymer layer 22 can connect with the polyolefin substrate 10, and an adhesive can be disposed between the fluorine-containing polymer layer 22 and the polyolefin substrate 10.

Specifically, a material of the auxiliary layer 21 includes the auxiliary polymer, such as PMMA or PU. A material of the fluorine-containing polymer layer 22 includes the foresaid fluorine-containing polymer. In an embodiment, the amount of the fluorine-containing polymer ranges from 70 wt % to 90 wt % based on the total weight of the antifouling and antibacterial layer 20.

It should be noted that the method of forming the antifouling and antibacterial layer 20 of the second embodiment is different from the method of forming the antifouling and antibacterial layer 20 of the first embodiment. In the second embodiment, the auxiliary polymer and the fluorine-containing polymer are respectively fed into two different tanks, and then the auxiliary polymer and the fluorine-containing polymer are co-extruded to form the antifouling and antibacterial layer 20 under a high temperature environment. In other words, the auxiliary layer 21 and the fluorine-containing polymer layer 22 of the second embodiment are manufactured in the same process, and the auxiliary layer 21 and the fluorine-containing polymer layer 22 are formed integrally.

### Third Embodiment

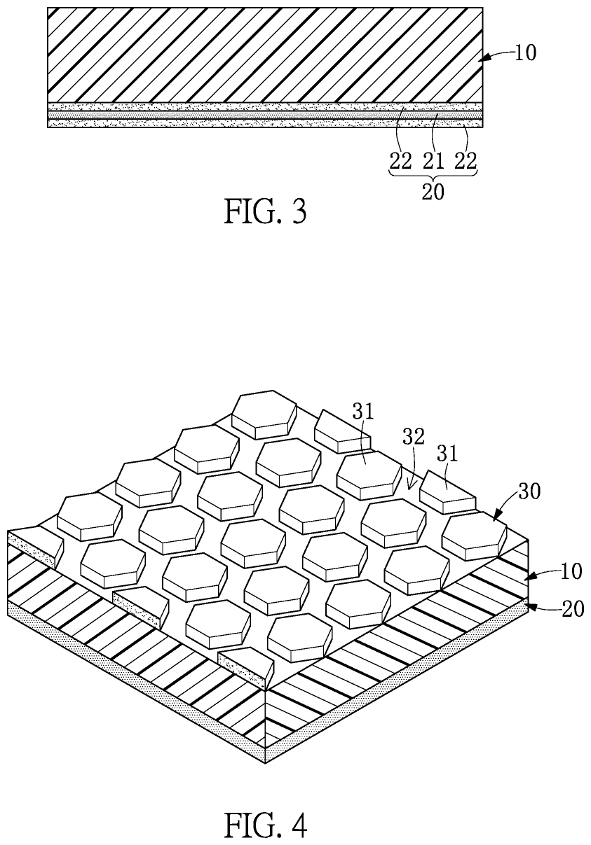

Referring to FIG. 3, the antifouling and antibacterial layer 20 is a laminated structure. The antifouling and antibacterial layer 20 includes an auxiliary layer 21 and two fluorine-containing polymer layers 22. The auxiliary layer 21 is formed between the two fluorine-containing polymer layers 22. One of the two fluorine-containing polymer layers 22 connects with the polyolefin substrate 10. When the antifouling and antibacterial layer 20 includes at least one auxiliary layer 21, an amount of the fluorine-containing polymer is decreased accordingly. Therefore, a material cost can be reduced and the antifouling and antibacterial effects can still remain the same.

In addition, the antifouling and antibacterial layer 20 includes any number of the auxiliary layer 21 and any number of the fluorine-containing polymer layers 22 which are stacked randomly. In a preferable embodiment, the auxiliary layer 21 and the fluorine-containing polymer layers 22 are staggeringly disposed on the polyolefin substrate 10. The polyolefin substrate 10 can optionally connect with the auxiliary layer 21 or the fluorine-containing polymer layers 22.

### Fourth Embodiment

Referring to FIG. 4, the antibacterial plastic surface material has a self-adhesive effect so that users can conveniently laminate the antibacterial plastic surface material onto objects without coating glue. Specifically, a patterned self-adhesive layer 30 is formed on a surface of the polyolefin substrate 10 opposite to the antifouling and antibacterial layer 20.

The self-adhesive layer 30 includes a plurality of adhesive units 31 arranged regularly and separate from each other. Every two adhesive units 31 are separated by an exhaust channel 32. In other words, the patterned self-adhesive layer 30 is a discontinuous film layer and dispersedly formed on the polyolefin substrate 10.

The exhaust channels 32 are channels for air to flow through between the antibacterial plastic surface material and a surface of an object connecting with the antibacterial plastic surface material. The exhaust channels 32 can provide ventilation and convenience for laminating the antibacterial plastic surface material. During a manual operation, the antibacterial plastic surface material is hard to be perfectly laminated onto the object and often forms bumps. Whereas, due to the exhaust channels 32 of the patterned self-adhesive layer 30, even if the antibacterial plastic surface material is not perfectly laminated onto the object, air can still be exhausted through the exhaust channels 32, instead of being sealed between the antibacterial plastic surface material and the object. Therefore, the antibacterial plastic surface material can be smoothly laminated on objects.

In FIG. 4, a shape of the adhesive units 31 is hexagon, but is not limited thereto. The shape of the adhesive units 31 also can be circle, triangle, quadrilateral, pentagon, or other geometric shapes.

[Antifouling and Antibacterial Property Test]

The antibacterial plastic surface material manufactured according to the first embodiment is processed an antifouling property test and an antibacterial property test so as to prove the antifouling and antibacterial effects of the present disclosure. Results of the antifouling property test and the antibacterial property test are listed in Table 1.

The difference between Examples and Comparative Examples is the material of the antifouling and antibacterial layer 20. Specifically, the material of the antifouling and antibacterial layer 20 of Example 1 is PVDF film whose amount of the fluorine-containing polymer is 100 wt %. The materials of the antifouling and antibacterial layer 20 of Examples 2 and 3 and Comparative Examples 1 and 2 are PVDF/PMMA composite films formed from the fluorine-containing solution with different weight ratio of PVDF and PMMA. The weight ratio of the PVDF of the PVDF/PMMA composite film is equal to the amount the fluorine-containing polymer of the antifouling and antibacterial layer 20. The materials of the antifouling and antibacterial layer 20 of Comparative Examples 3 and 4 are respectively a PMMA film and a PE film whose amount of the fluorine-containing polymer is 0 wt %. The specific materials of the fluorine-containing polymer of Examples 1 to 3 and Comparative Examples 1 to 4 are listed in Table 1.

TABLE 1
the materials of the fluorine-containing polymer of
Examples 1 to 3 (E1 to E3) and Comparative Examples
1 to 4 (C1 to C4), and the results of the antifouling
property test and the antibacterial property test

| | | Antifouling property test | | | |
|---|---|---|---|---|---|
| | Material of the | ball- | | | |
| | antifouling and | point | Oily | Medical | Antibacterial |
| | antibacterial layer | pen | Marker | iodine | property test |
| E1 | PVDF film | ⊚ | ⊚ | ⊚ | 0 |
| E2 | PVDF/PMMA | ◯ | ◯ | ◯ | 0 |
| | composite film | | | | |
| | (PVDF:PMMA = 90:10) | | | | |
| E3 | PVDF/PMMA | ◯ | ◯ | ◯ | 1 |
| | composite film | | | | |
| | (PVDF:PMMA = 80:20) | | | | |
| C1 | PVDF/PMMA | Δ | Δ | Δ | 2 |
| | composite film | | | | |
| | (PVDF:PMMA = 50:50) | | | | |
| C2 | PVDF/PMMA | X | X | X | 3 |
| | composite film | | | | |
| | (PVDF:PMMA = 20:80) | | | | |
| C3 | PMMA film | X | X | X | 4 |
| C4 | PE film | X | X | X | 4 |

In Table 1, “⊚” is represented by excellent antifouling property; that is, stains can be removed after lightly wiping. “◯” is represented by good antifouling property. “Δ” is represented by poor antifouling property. “X” is represented by bad antifouling property. In addition, the antibacterial property is tested according to standard ASTM-G21 conducted by American Society for Testing and Materials (ASTM). In the antibacterial property test, if no mold grows after 28 days of bacterial culture, the level of the antibacterial property is assessed as “0”. If mold slightly grows after 28 days of bacterial culture (an area of mold growth smaller than 10%), the level of the antibacterial property is assessed as “1”. If mold mildly grows after 28 days of bacterial culture (an area of mold growth larger than 10% to 30%), the level of the antibacterial property is assessed as “2”. If mold moderately grows after 28 days of bacterial culture (an area of mold growth larger than 30% to 60%), the level of the antibacterial property is assessed as “3”. If mold severely grows after 28 days of bacterial culture (an area of mold growth larger than 60%), the level of the antibacterial property is assessed as “4”.

According to Table 1, the antifouling and antibacterial layer of Examples 1 to 3 have better antifouling property and antibacterial property than the antifouling and antibacterial layer of Comparative Examples 1 to 4. When the antifouling and antibacterial layer includes at least 70 wt % of the fluorine-containing polymer, the antifouling and antibacterial layer can have good antifouling property and antibacterial property. Further, when the antifouling and antibacterial layer includes a higher amount of the fluorine-containing polymer, the antifouling and antibacterial layer can have better antifouling property and antibacterial property.

In conclusion, the antibacterial plastic surface material of the present disclosure has technical features of “a polyolefin substrate 10 whose material includes 30 wt % to 60 wt % of linear polyethylene and 40 wt % to 70 wt % of propylene homopolymer” and “a material of the antifouling and antibacterial layer 20 includes at least 70 wt % of fluorine-containing polymer” so as to possess the antifouling and antibacterial properties. In addition, the problems generated by using PVC film as a main body and adding plasticizers can be overcome.

Further, the antibacterial plastic surface material of the present disclosure has technical feature of “the fluorine-containing polymer is at least one selected from the group consisting of: polyvinylidene difluoride, polytetrafluoroethylene, and polyvinylfluoride” so as to enhance the antifouling property and antibacterial properties.

Further, the antibacterial plastic surface material of the present disclosure has technical features of “the antifouling and antibacterial layer 20 includes an auxiliary layer 21 and a fluorine-containing polymer layer 22” and “the fluorine-containing polymer based on a total weight of the antibacterial plastic surface material ranges from 70 wt % to 90 wt %” so that a material cost can be reduced by decreasing an usage of the fluorine-containing polymer and the antifouling effect and the antibacterial effect can still be maintained the same.

Further, the antibacterial plastic surface material of the present disclosure has technical features of “the antibacterial plastic surface material includes a patterned self-adhesive layer 30” and “the patterned self-adhesive layer 30 discretely formed on a surface of the polyolefin substrate 10 opposite to the antifouling and antibacterial layer 20” so as to enhance the convenience of laminating the antibacterial plastic surface material and increase the smoothness after laminating of the antibacterial plastic surface material.

Further, the antibacterial plastic surface material of the present disclosure has the technical feature of “the antifouling and antibacterial layer 20 is formed on the polyolefin substrate 10 by laminating” so that the antifouling and antibacterial layer 20 is formed on the polyolefin substrate 10 in a continuous manner to protect the polyolefin substrate 10.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An antibacterial plastic surface material, comprising:
a polyolefin substrate composed of materials including 30 wt % to 60 wt % of linear polyethylene and 40 wt % to 70 wt % of propylene homopolymer; and
an antifouling and antibacterial layer formed on the polyolefin substrate, a material of the antifouling and antibacterial layer including at least 70 wt % of a fluorine-containing polymer.

2. The antibacterial plastic surface material according to claim 1, wherein the fluorine-containing polymer is at least one selected from the group consisting of: polyvinylidene difluoride, polytetrafluoroethylene, and polyvinylfluoride.

3. The antibacterial plastic surface material according to claim 1, wherein the antifouling and antibacterial layer includes at least one auxiliary layer and at least one fluorine-containing polymer layer, and the polyolefin substrate connects with the auxiliary layer or the fluorine-containing polymer layer; wherein the fluorine-containing polymer layer includes the fluorine-containing polymer, and a content of the fluorine-containing polymer based on a total weight of the antibacterial plastic surface material ranges from 70 wt % to 90 wt %.

4. The antibacterial plastic surface material according to claim 3, wherein a material of the at least one auxiliary layer is polymethylmethacrylate, polyurethane resin, or a combination thereof.

5. The antibacterial plastic surface material according to claim 3, wherein the antifouling and antibacterial layer is a laminated structure, and the at least one auxiliary layer and the at least one fluorine-containing layer are staggeringly disposed on the polyolefin substrate.

6. The antibacterial plastic surface material according to claim 3, wherein the polyolefin substrate connects with the at least one auxiliary layer, and an adhesive is formed between the polyolefin substrate and the at least one auxiliary layer.

7. The antibacterial plastic surface material according to claim 1, wherein a thickness of the antifouling and antibacterial layer is 10 μm to 50 μm.

8. The antibacterial plastic surface material according to claim 1, wherein the antibacterial plastic surface material further includes a patterned self-adhesive layer discretely formed on a surface of the polyolefin substrate opposite to the antifouling and antibacterial layer.

9. The antibacterial plastic surface material according to claim 8, wherein the patterned self-adhesive layer includes a plurality of adhesive units arranged regularly and an exhaust channel, and the plurality of adhesive units are separated by the exhaust channel.

10. The antibacterial plastic surface material according to claim 1, wherein the antifouling and antibacterial layer is formed on the polyolefin substrate by laminating.
